(19) United States
(12) Patent Application Publication
(10) Pub. No.: US 2007/0197733 A1
(43) Pub. Date: Aug. 23, 2007

(54) Star macromonomers and polymeric materials and medical devices comprising same

(75) Inventors: Joseph C. Salamone, Boca Raton, FL (US); Jay F. Kunzler, Canandaigua, NY (US)

Correspondence Address: Bausch & Lomb Incorporated, One Bausch & Lomb Place, Rochester, NY, 14604-2701, US

(73) Assignee: Bausch & Lomb Incorporated

(21) Appl. No.: 11/359,860

(22) Filed: Feb. 22, 2006

(51) Int. Cl. C08F 297/02

(52) U.S. Cl. 525/242

(57) ABSTRACT

A star macromonomer comprises multiple side chains attached to a nucleus, each side chain having at least a segment comprising hydrophobic units and at least a segment comprising hydrophilic units. Polymeric materials having improved oxygen permeability and water and ion transport rates are produced by polymerizing compositions comprising such a star macromonomer. Such polymeric materials are desirable for producing medical devices, such as ophthalmic devices.

### BACKGROUND OF THE INVENTION

The present invention relates to star macromonomers and polymeric materials and medical devices comprising such materials, and methods of making such materials and devices. In particular, the present invention relates to ophthalmic devices comprising star macromonomers and having enhanced ion and water transport properties.

Advances in the chemistry of materials for medical devices have increased their compatibility with a body environment and their comfort for extended use therein. The extended use of contact lenses requires that materials for these lenses allow sufficient rates of transport of oxygen to the cornea to preserve its health because the cornea does not have blood vessels for the supply of oxygen and must receive this gas by its diffusion through the epithelial layer on the outer surface of the cornea. On the other hand, the cornea continuously regulates its thickness by actively pumping ions in or out of the cornea to counterbalance a continuous leak of fluid into the corneal stroma. A net flux of sodium ions from the stroma to the anterior chamber has been measured in animal models (see, e.g., S. Hodson et al., Exp. Eye Res., Vol. 11, 249-253 (1977); J. A. Bonanno, Prog. in Retinal and Eye Res., Vol. 22, 69-94 (2003)). Thus, contact lenses for extended use also should allow sufficient rates of ion transport therethrough. Moreover, in view of the need rapidly to regulate the cornea thickness, the desirable materials should have an ion transport rate as high as possible. Although materials have been developed that show high oxygen permeability, those having remarkable ion permeability have not been noticed.

While there exist rigid gas permeable (“RGP”) contact lenses, which have high oxygen permeability and which move on the eye, RGP lenses are typically quite uncomfortable for the wearer. Thus, soft contact lenses are preferred by many wearers because of comfort. (Soft materials are those exhibiting low modulus of elasticity, such as less than about 150 g/mm².) Moreover, a contact lens which may be continuously worn for a period of a day or more (including wear during periods of sleeping) requires comfort levels that exclude RGP lenses as popular extended-wear candidates. Among the soft contact lens materials having high oxygen permeability have been polymers containing siloxane groups. For example, see U.S. Pat. Nos. 3,228,741; 3,341,490; 3,996,187; and 3,996,189. However, polysiloxanes are typically highly hydrophobic and lipophilic. The properties (e.g., lipophilicity, glass transition temperature, mechanical properties) of known polysiloxanes have resulted in contact lenses that adhere to the eye, inhibiting the necessary lens movement. In addition, polysiloxane lipophilicity promotes adhesion to the lens of lipids and proteins in the tear fluid, causing a haze, which interferes with vision through the lens.

Therefore, there have been efforts to develop hydrophilic polymers, which have both high hydrophilicity and high oxygen permeability. Such polymers typically combine a hydrophilic monomer (such as 2-hydroxyethyl methacrylate (“HEMA”), N-vinyl-2-pyrrolidone (“NVP”), N,N-dimethyl acrylamide (“DMA”), methacrylic acid “MAA”), or acrylic acid) and units of siloxane-containing monomers. For example, see U.S. Pat. Nos. 3,808,178; 4,136,250; and 5,070,169. These polymers typically are random copolymers. Other works have been directed to develop block copolymers, such as those consisting of polysiloxane and polyoxyalkylene blocks. See, for example, EP 267158, EP 330615, EP 330616, and EP 330617.

Although there have been attempts to develop materials for contact lenses that have both high oxygen permeability and high ion transport rate, such materials have not been apparent. For example, U.S. Pat. Nos. 5,807,944 and 5,849,811 disclose polymers comprising blocks or segments of polymers having high oxygen permeability and blocks or segments of polymers that are said to have high ion permeability. The oxygen-permeable blocks comprise a siloxane-containing macromonomer, such as polydimethylsiloxane that may include hydrophilic groups. The ion-permeable blocks comprise units of a typical hydrophilic monomer that has been used to synthesize hydrophilic polymers, including the monomers disclosed above or cyclic ethers having only one oxygen atom in the ring. Although a range of ion diffusion rates through these materials was achieved, these rates may still be inadequate for the cornea health, and higher rates are still desirable.

Therefore, there is a continued need to provide other materials for medical devices in general, and contact lenses in particular, that have both improved oxygen permeability and ion transport rate. It is also very desirable to provide materials for such devices that have improved oxygen permeability and ion and water transport rates.

### BRIEF SUMMARY OF THE INVENTION

In general, the present invention provides a polymeric material that has an improved oxygen permeability and water and ion transport rate.

In one aspect, the present invention provides a star macromonomer comprising multiple side chains attached to a nucleus, each side chain having at least a segment comprising hydrophobic units and at least a segment comprising hydrophilic units.

In another aspect, the star macromonomer comprises at least three side chains.

In still another aspect, said at least a segment comprising hydrophobic units comprises a polysiloxane chain.

In still another aspect, the present invention provides a polymeric material comprising a product of a polymerization of such a star macromonomer.

In still another aspect, the present invention provides a polymeric material comprising a product of a polymerization of such a star macromonomer and at least another monomer selected from the group consisting of hydrophobic monomers, hydrophilic monomers, combinations thereof, and mixtures thereof.

In yet another aspect, the present invention provides a method for making a star macromonomer. The method comprises: (a) effecting a polymerization of a first monomeric units on a multi-functional initiator to produce a first star-shaped compound having multiple side chains; (b) effecting a polymerization of a second monomeric units on the first star-shaped compound to produce a second star-shaped compound having multiple side chains comprising a segment of first monomeric units and a segment of second monomeric units; and (c) attaching polymerizable groups to terminal groups of the multiple side chains of the second star-shaped compound to produce the star macromonomer.

In a further aspect, the present invention provides medical devices comprising a polymeric material that comprises units of star macromonomers having multiple side chains, each side chain comprising at least a segment of hydrophobic monomeric units and at least a segment of hydrophilic monomeric units.

In still another aspect, the medical devices are ophthalmic devices.

Other features and advantages of the present invention will become apparent from the following detailed description and claims.

### DETAILED DESCRIPTION

The term “lower alkyl” means an alkyl group having any number of carbon atoms from 1 to, and including, 10 (e.g., 1, 2, 3, 4, 5, 6, 7, 8, 9, or 10). A lower alkyl group can be a linear (e.g., having 1-10 carbon atoms), branched (e.g., having 3-10 carbon atoms), or cyclic (e.g., having 3-10 carbon atoms) alkyl.

The phrase “from i to j” (wherein i and j are integers) means the range from i to j, including i and j.

The term “(meth)acrylate” includes acrylate and methacrylate. Similar meanings apply to other analogous terms of “(meth)acrylate.”

In general, the present invention provides a polymeric material that has an improved oxygen permeability and ion transport rate.

In one aspect, the present invention provides a polymeric material that has an improved oxygen permeability and ion and water transport rates.

In one aspect, the present invention provides a star macromonomer comprising multiple side chains attached to a nucleus, each side chain having at least a segment comprising hydrophobic units and at least a segment comprising hydrophilic units. A plurality of such side chains comprises terminal polymerizable groups. In one embodiment, at least three such side chains comprise terminal polymerizable groups.

In another aspect, a star macromonomer of the present invention has a formula of
X-{(A-D)ᵢ-G}ₘ (I)
wherein X comprises a nucleus; A comprises a segment comprising a plurality of hydrophobic monomeric units or hydrophilic units; D comprises: (a) a segment comprising a plurality of hydrophilic monomeric units if A comprises a segment comprising a plurality of hydrophobic monomeric units, or (b) a segment comprising a plurality of hydrophobic monomeric units if A comprises a segment comprising a plurality of hydrophilic monomeric units; G comprises a polymerizable group; m is an integer equal to or greater than 3; and i is an integer such that 1≦i≦1000.

In one aspect, the nucleus comprises a multicarbanionic group, a multi-functional silane or siloxy group, or a derivative thereof.

Non-limiting examples of the polymerizable group G are vinyl, allyl, vinyloxy, acryloyl, acryloyloxy, methacryloyl, methacryloyloxy, epoxide, isocyanate, isothiocyanate, amino, hydroxyl, mercapto, anhydride, carboxylic, fumaryl, styryl, itaconyl, maleimido, methacrylamido, acrylamido, and combinations thereof.

In another aspect, the star macromonomer comprises at least three side chains.

In one embodiment, 3≦m≦20. Alternatively, 3≦m≦10, or 3≦m≦5.

In another embodiment, 1≦i≦500, or 1≦i≦100, or 1≦i≦20, 1≦i≦10, or 1≦i≦5.

In still another aspect, a macromonomer of the present invention has Formula II or III. 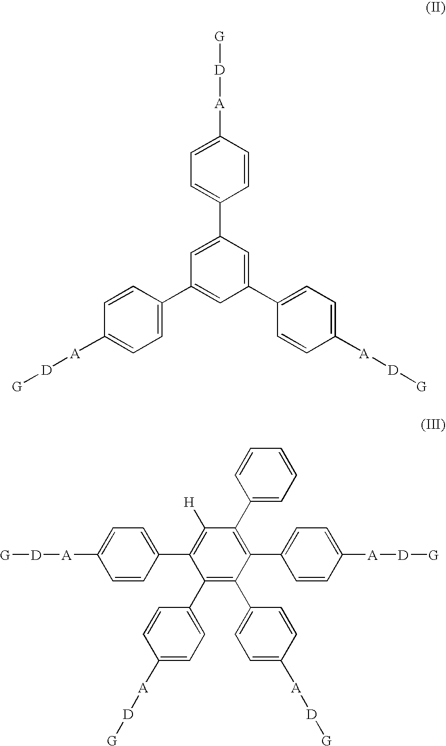
wherein A, D, and G are defined above. It should be noted that each A group may be the same as or different from other A groups; each D group may be the same as or different from other D groups; and each G group may be the same as or different from other G groups. It should be noted that in some embodiments of the present invention, the positions of A and D relative to the nucleus in Formulas II and III may be switched.

In one embodiment, A comprises a segment comprising hydrophobic monomeric units and B comprises a segment comprising hydrophilic monomeric units. In another embodiment, A comprises a segment comprising hydrophilic monomeric units and B comprises a segment comprising hydrophobic monomeric units. Non-limiting examples of hydrophobic and hydrophilic monomers are disclosed below.

In another embodiment, the hydrophobic units comprise siloxy units.

In one aspect, a macromonomer of the present invention has Formula IV or V. 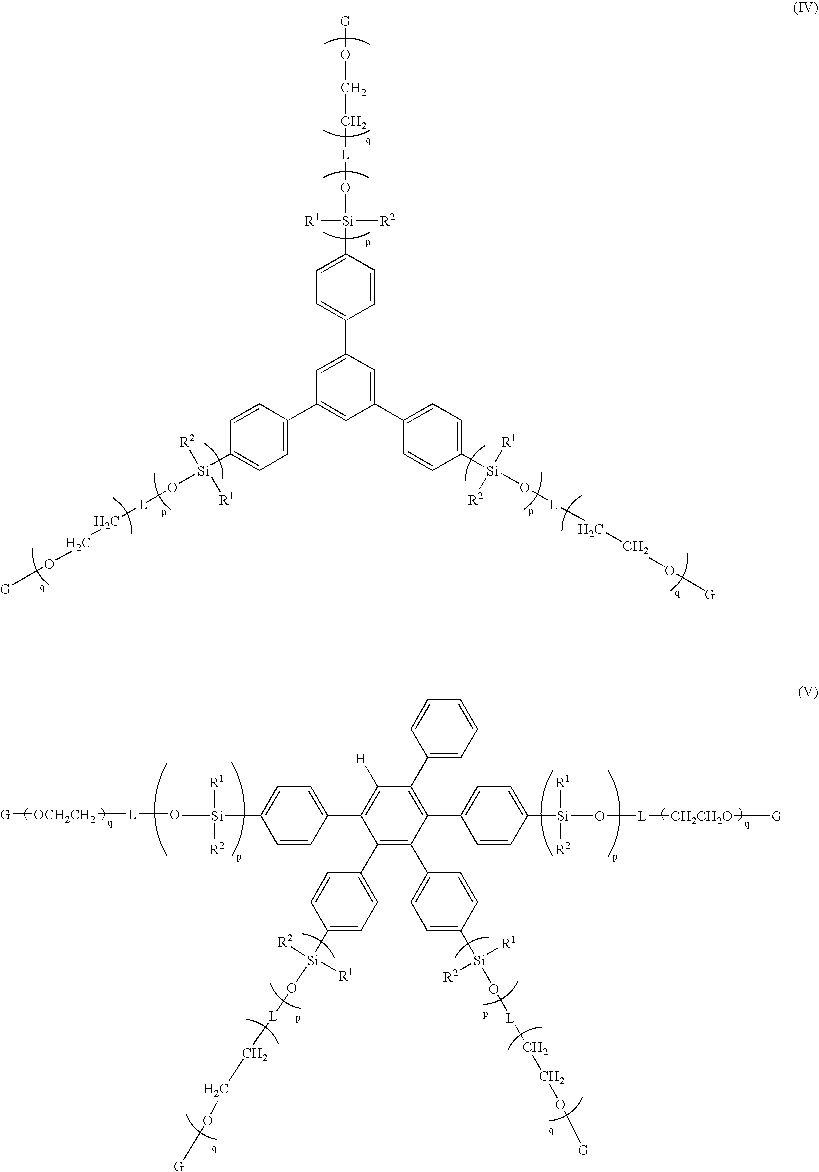
wherein each R¹ or R² are the same as or different from other R¹ or R² and is selected from the group consisting of unsubstituted and substituted alkyl groups having from 1 to, and including, 20 carbon atoms (alternatively, from 1 to, and including, 10 carbon atoms), unsubstituted and substituted C₆-C₃₆ aromatic groups, unsubstituted and substituted C₆-C₃₆ heterocyclic groups, and combinations thereof; L is a direct bond or a divalent linking group; and p and q are independently selected positive integers greater than or equal to 2. In one embodiment, at least one of R¹ and R² comprises an unsubstituted and substituted C₆-C₃₆ aromatic group. In another embodiment, the aromatic groups are selected from the group consisting of unsubstituted and substituted phenyl, biphenyl, naphthyl, benzyl, anthryl, and combinations thereof. In another embodiment, at least one of R¹ and R² is a C₆-C₃₆ aromatic group. In another embodiment, at least one of R¹ and R² comprises fluorinated lower alkyl groups or fluorinated C₆-C₃₆ aromatic groups. In still another embodiment, L comprises linear, branched, or cyclic groups comprising carbon, hydrogen, heteroatoms (such as, for example, oxygen, silicon, nitrogen, phosphorus, sulfur, halogen, or combinations thereof), and/or combinations thereof.

In one embodiment, at least one of R¹ and R² comprises a group having a formula of —(CH₂)ⱼ—(CF₂)ₖ—R″, wherein j and k are independently selected integers in the range from 1 to, and including, 10; and R″ is H, F, or a lower alkyl group. In another embodiment, said —(CH₂)ⱼ—(CF₂)ₖ—R″ group comprises from 1 to, and including, 10 carbon atoms.

In one embodiment, the polymerizable group comprises vinyl, allyl, vinyloxy, acrylate, methacrylate, maleate, fumarate, styryl, or combinations thereof.

In another embodiment, p and q are independently selected integers, and 2≦p, q≦10000. Alternatively, 20≦p, q≦5000, or 20≦p, q≦2000, or 50≦p, q≦1000, or 50≦p, q≦500, or 20≦p, q≦100.

In another embodiment, a macromonomer of the present invention has Formula VI or VII, wherein L, p, and q are defined above.

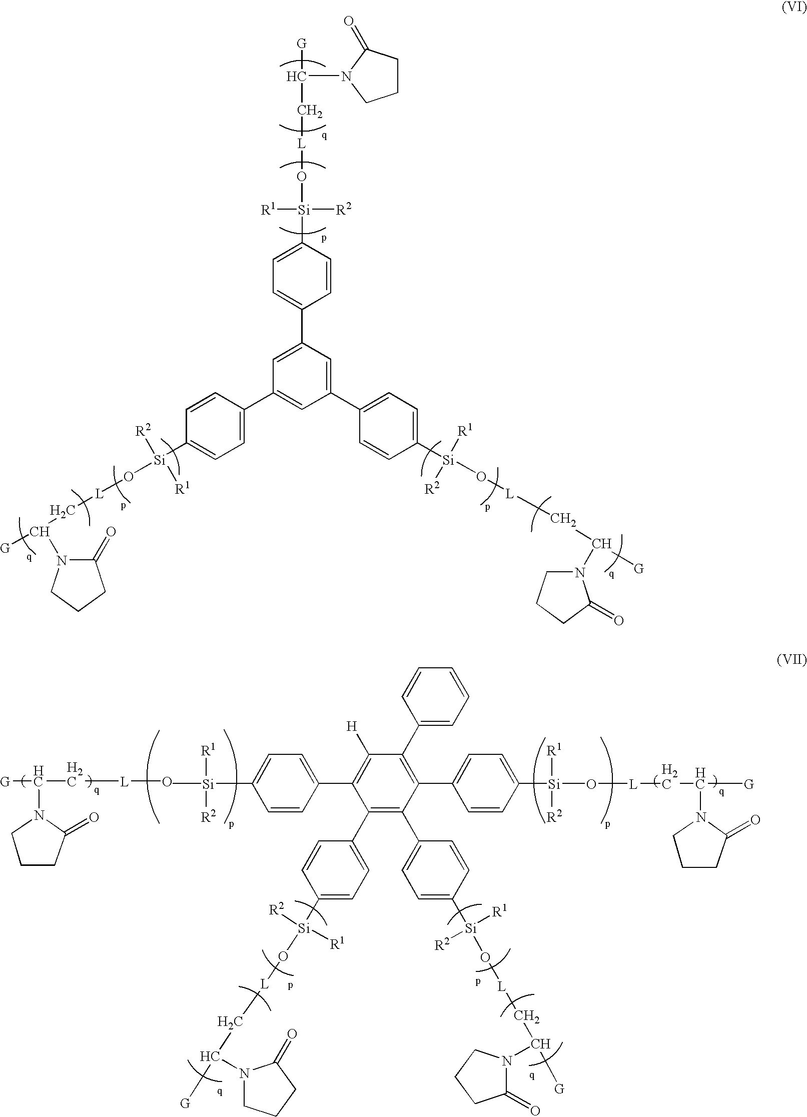

In another embodiment, a macromonomer of the present invention has Formula VIII or IX. 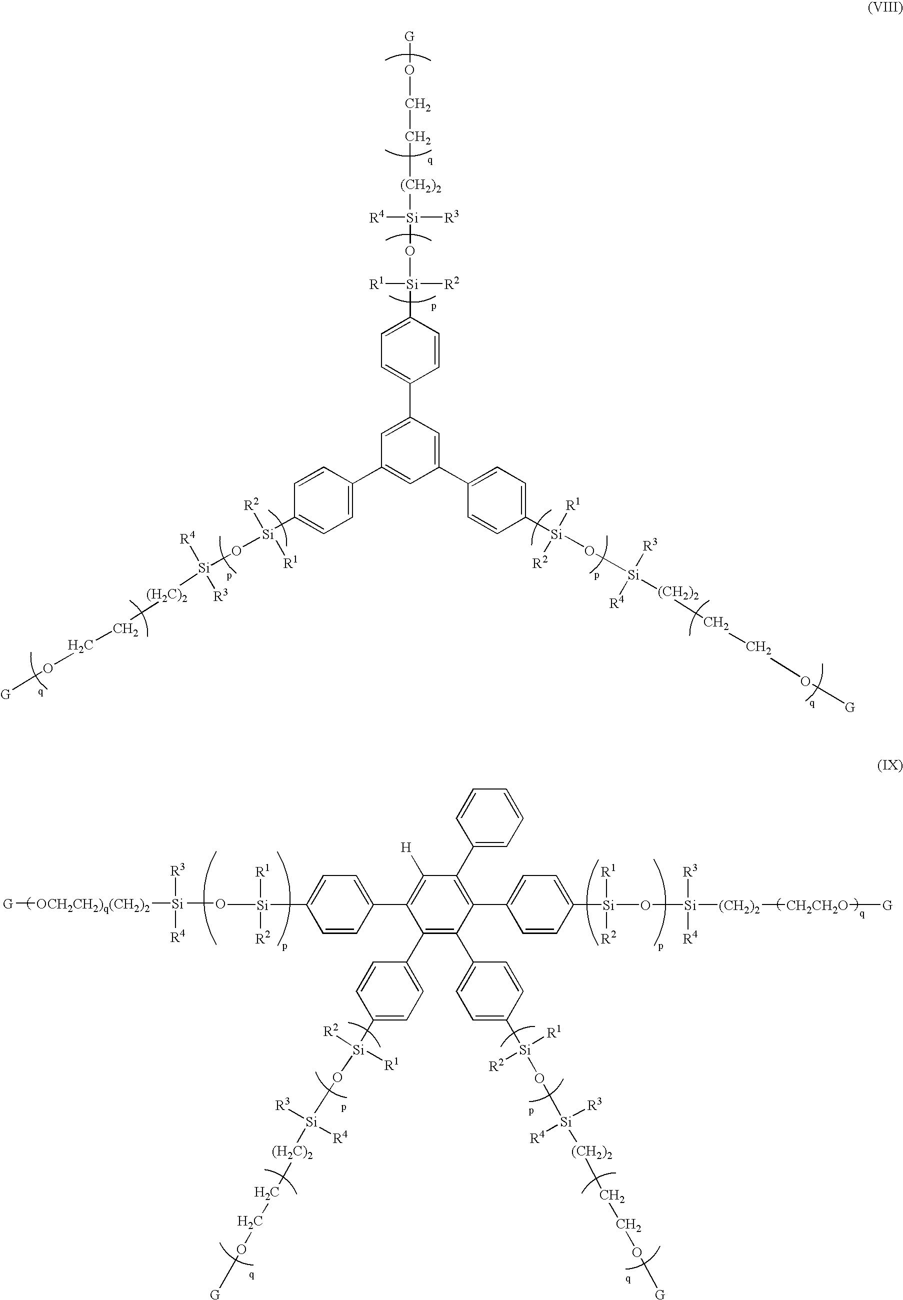
wherein R¹, R², G, p, and q are defined above, and R³ and R⁴ are independently selected from the group consisting of unsubstituted and substituted lower alkyl groups, unsubstituted and substituted C₆-C₃₆ aromatic groups, unsubstituted and substituted C₆-C₃₆ heterocyclic groups, and combinations thereof.

In another aspect of the present invention, a method of making a star macromonomer comprises: (a) effecting a polymerization of a first monomeric units on a multi-functional initiator to produce a first star-shaped compound having multiple side chains; (b) effecting a polymerization of a second monomeric units on the first star-shaped compound to produce a second star-shaped compound having multiple side chains comprising a segment of first monomeric units and a segment of second monomeric units; and (c) attaching polymerizable groups to terminal groups of the multiple side chains of the second star-shaped compound to produce the star macromonomer.

In still another aspect, the multi-functional initiator comprises a multicarbaion, a multi-functional silane group, or a multi-functional siloxy group.

For example, a macromonomer of Formula VIII, such as XX, can be produced according to Scheme 1. 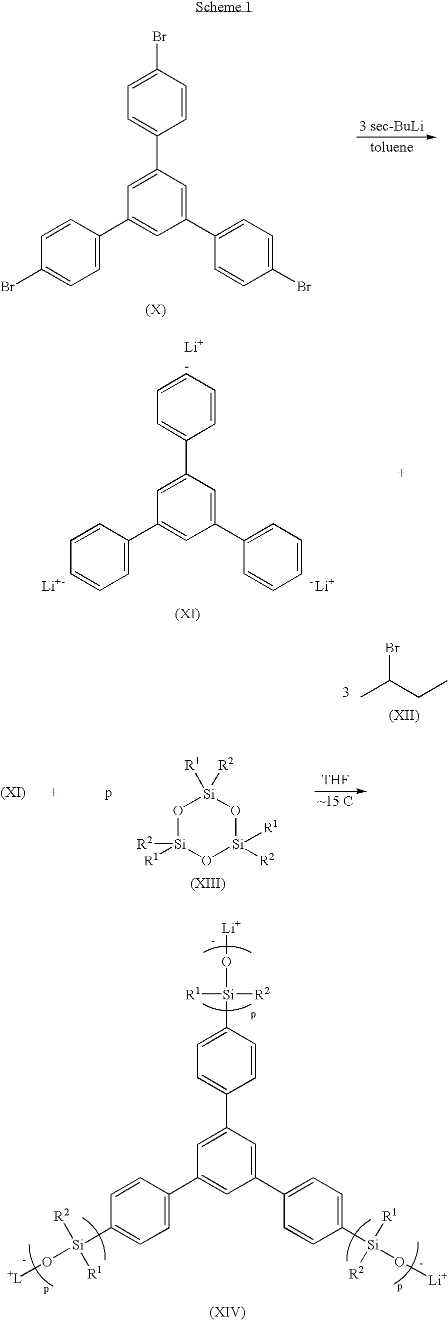 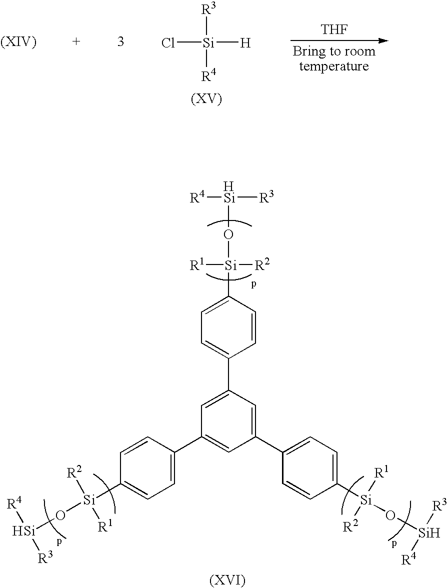
wherein R³ and R⁴ are disclosed above. After this step, the reaction mixture may be washed with acetonitrile. 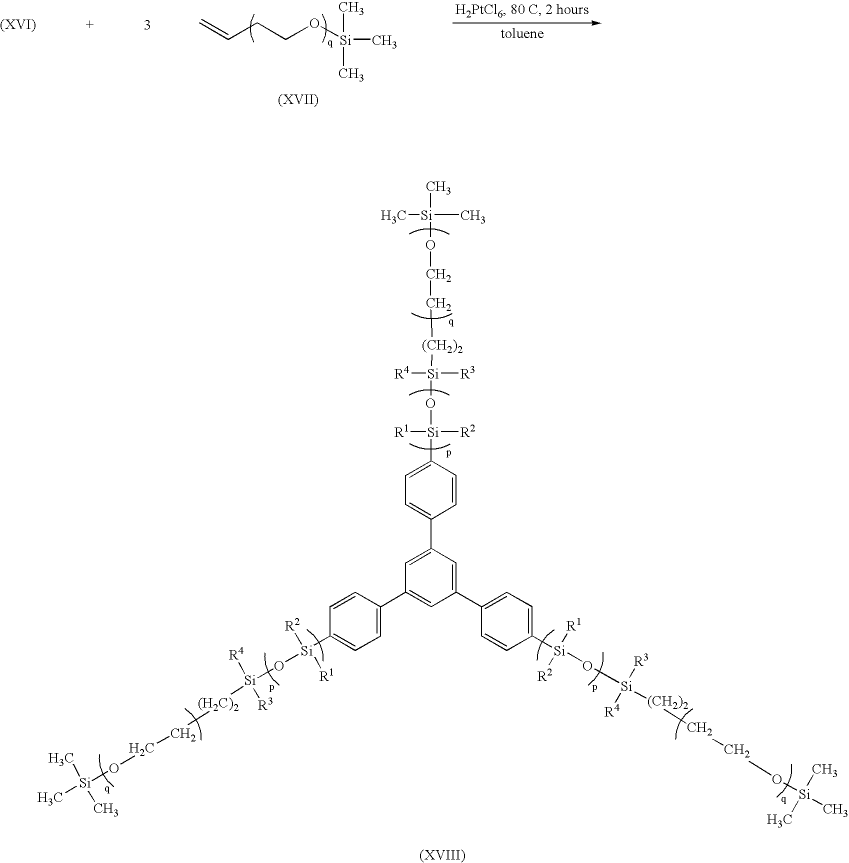
Note that XVII is commercially available, for example, from Gelest, Inc. (Morrisville, Pa.).

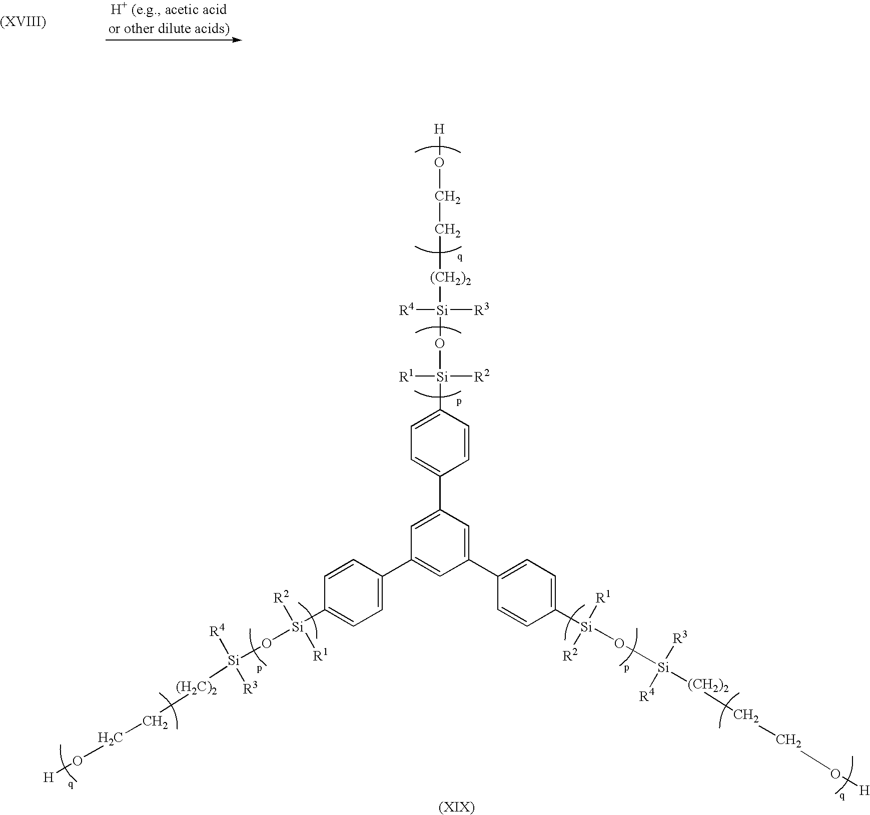

At this point, another segment comprising a plurality of siloxy units and another segment comprising polyoxyethylene may be attached to the terminals of the side chains, if desired, by repeating the steps disclosed above. Thus, a star polymer having side chains comprising a plurality of alternate hydrophobic and hydrophilic segments can be produced. 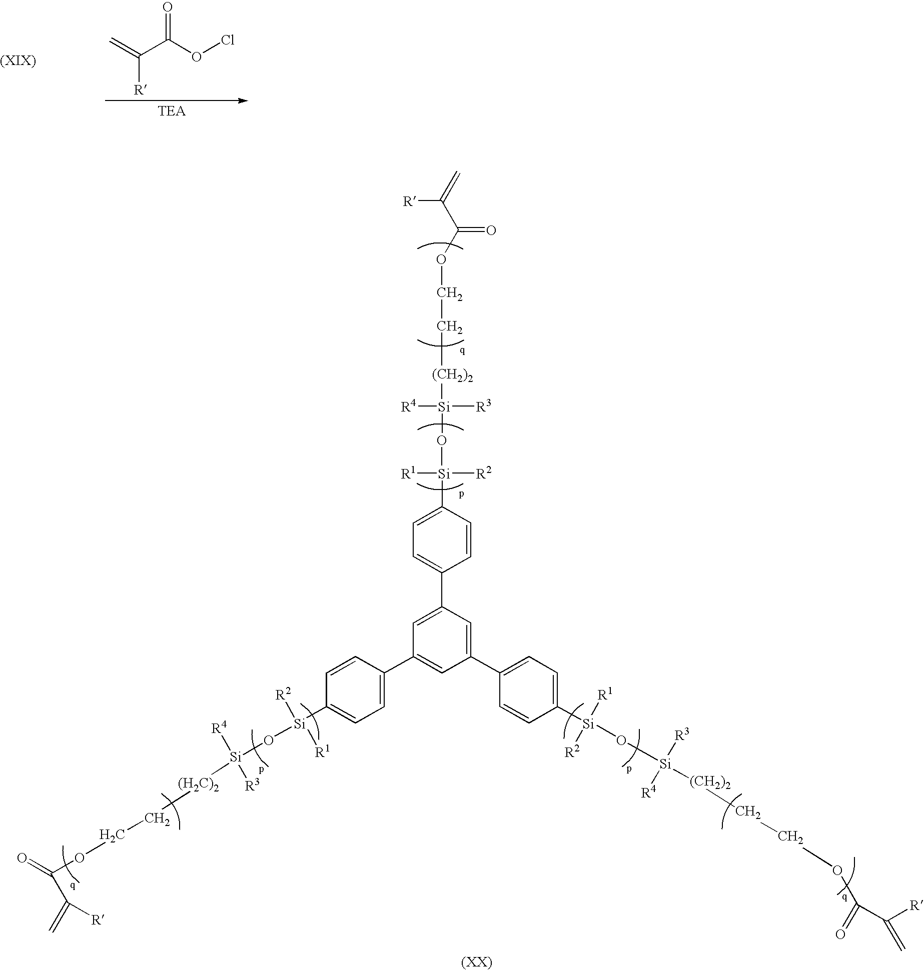
wherein R′ is CH₃ or H.

In other embodiments of the present invention, acryl chloride or methacryl chloride employed in the last step of Scheme 1 can be replaced by, for example, isocyanatoethyl(meth)acrylate or glycidyl(meth)acrylate as alternatives for providing terminal (meth)acrylate groups on the star macromonomer. Alternatively, compound XIX can be reacted with a fumaryl chloride ester, vinyldimethyloxazolone (“VDMO”), or chloromethylstyrene (such as 4-chloromethylstyrene) to produce a star macromonomer having terminal polymerizable double bonds.

Similarly, a compound of Formula IX, such as XXVII, can be produced according to Scheme 2. 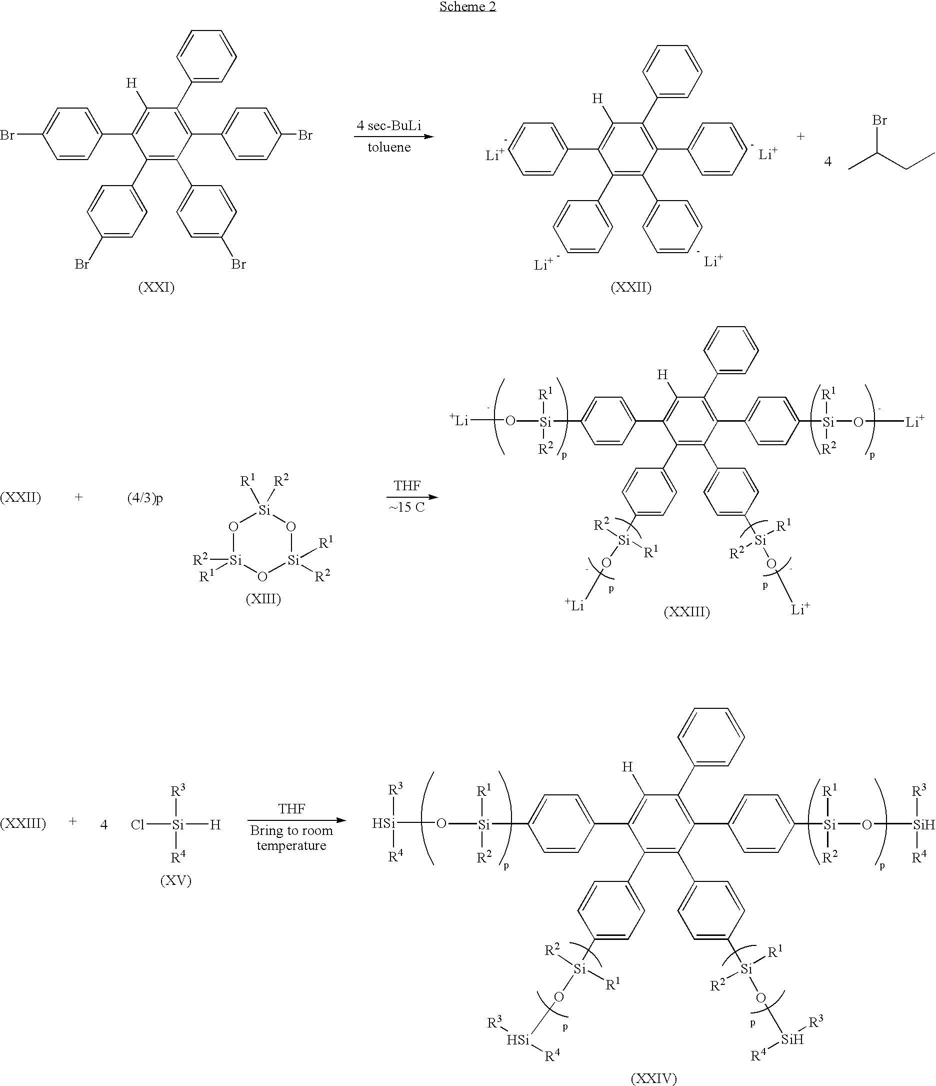 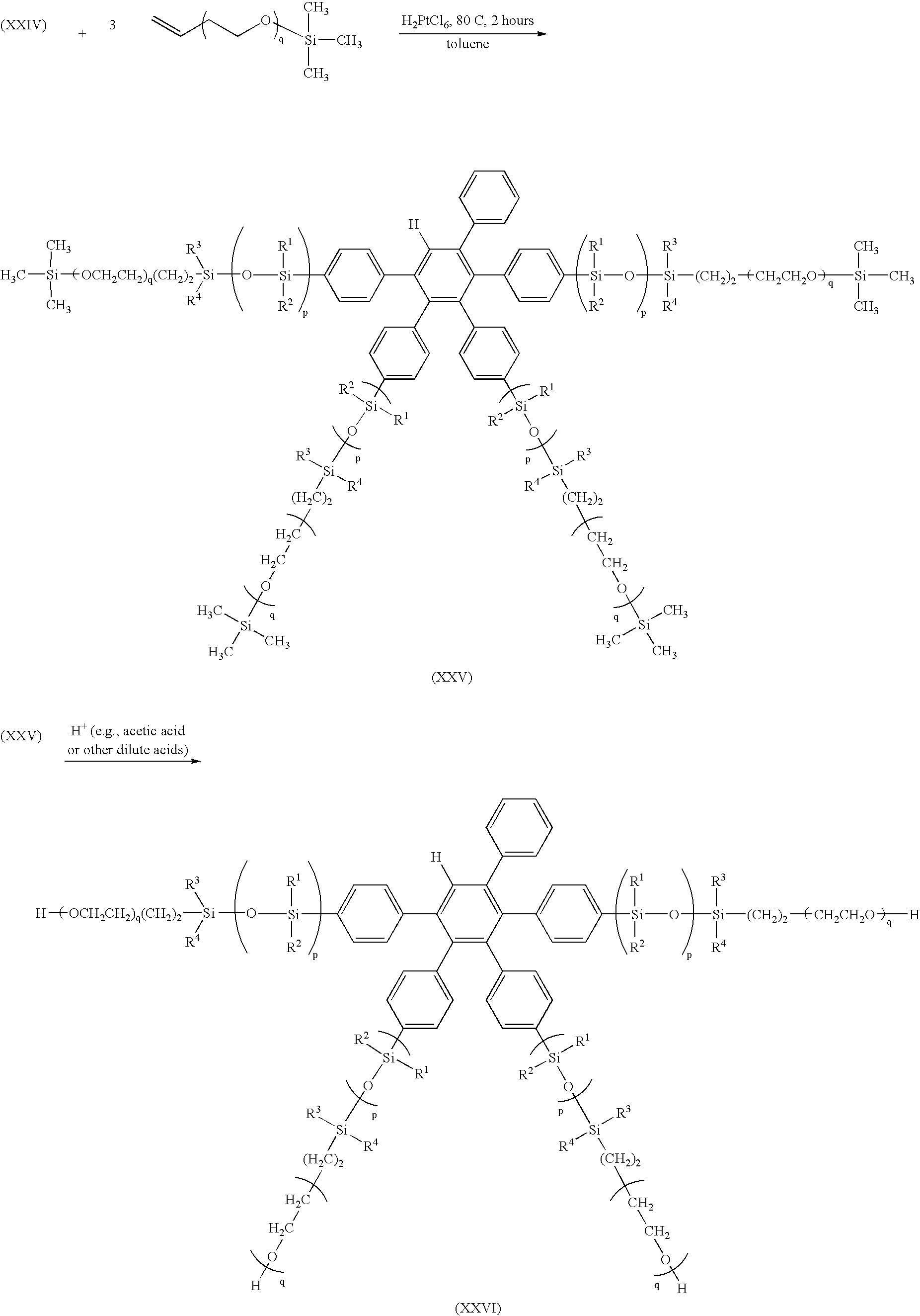 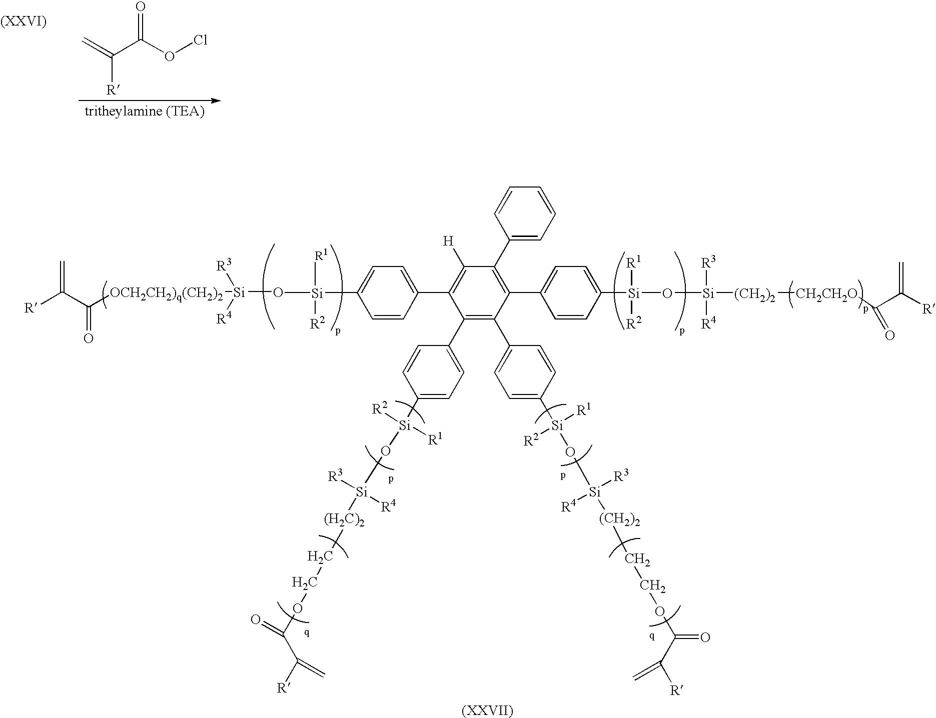
wherein the chloroplatinic acid catalyst can be replaced by, for example, platinum divinyltetramethyl disiloxane catalyst, and R′ is CH₃ or H.

In other embodiments of the present invention, acryl chloride or methacryl chloride employed in the last step of Scheme 2 can be replaced by, for example, isocyanatoethyl(meth)acrylate or glycidyl(meth)acrylate as alternatives for providing terminal (meth)acrylate groups on the star macromonomer. Alternatively, compound XXVI can be reacted with a fumaryl chloride ester, vinyldimethyloxazolone (“VDMO”), or chloromethylstyrene (such as 4-chloromethylstyrene) to produce a star macromonomer having terminal polymerizable double bonds.

Compounds X and XXI can be made by a procedure disclosed by R. Matmour et al., Angew. Chem., Vol. 117, 288-291 (2005). For example, compound X can be obtained from 4-bromoacetophenone diethyl ketal and acetyl chloride with samarium trichloride as catalyst. Compound XXI can be prepared by Diels-Alder reaction of 2,3,4,5-tetrakis(p-bromophenyl)cyclopentadienone and phenylacetylene.

In another embodiment, a star macromonomer having a siloxy nucleus and segments of hydrophobic and hydrophilic units can be produced, for example, according to Scheme 3. 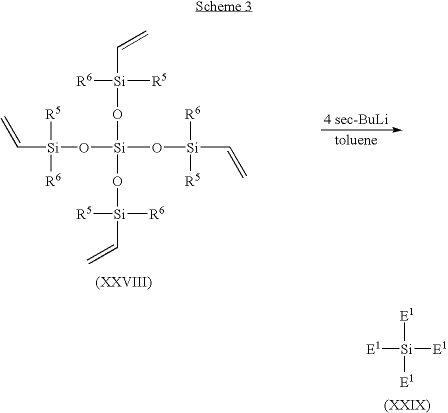
wherein R⁵ and R⁶ are independently selected from the group consisting of unsubstituted and substituted lower alkyl groups, unsubstituted and substituted C₆-C₃₆ aromatic groups, unsubstituted and substituted C₆-C₃₆ heterocyclic groups, and combinations thereof; E¹ represents 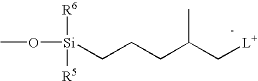
and compound XXVIII can be produced by reacting tetrachlorosilane with a stoichiometric amount of vinyldimethylchlorosilane in the presence of water. In an alternative embodiment, compound XXVIII, serving as the starting nucleus of the star macromonomer, may be replaced by tetravinylsilane (commercially available, for example, from Gelest, Inc.). The subsequent steps for the synthesis of a star macromonomer started with tetravinylsilane are the same as those disclosed below. 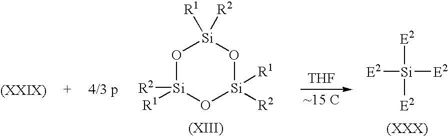
wherein E² represents 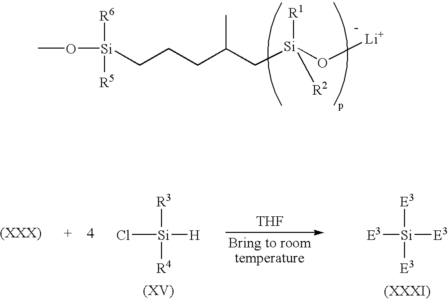
wherein E³ represents 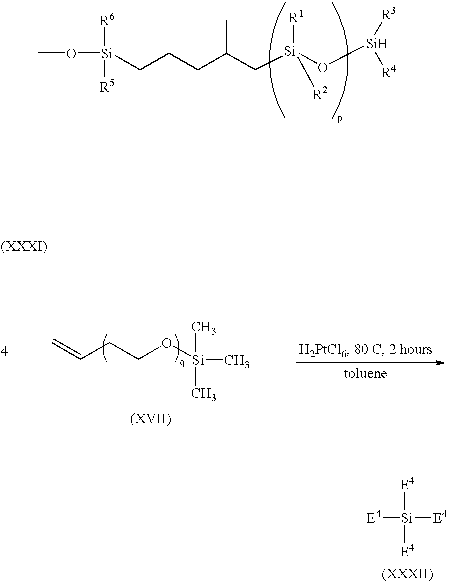
wherein the chloroplatinic acid catalyst can be replaced by, for example, platinum divinyltetramethyl disiloxane catalyst, and E⁴ represents 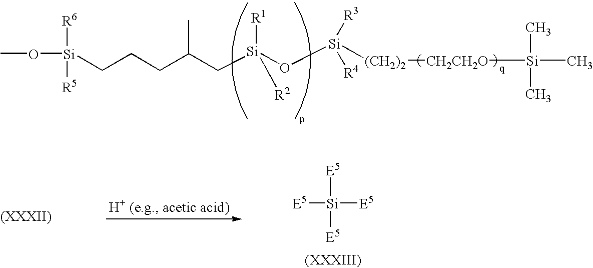
wherein E⁵ represents

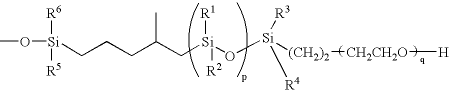

The above step is an acid hydrolysis. It can be carried out in the presence of acids other than acetic acid; e.g., other alkanoic acids (such as C₂-C₅ alkanoic acids), nitric acid, hydrochloric acid, phosphoric acid, or sulfuric acid. 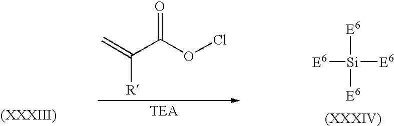
wherein E⁶ represents 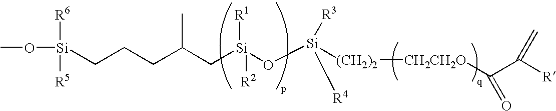
and R′ is CH₃ or H.

When the starting nucleus is tetravinylsilane, the final star macromonomer produced in a process similar to that disclosed immediately above has Formula XXXV. 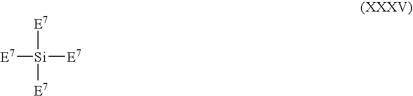
wherein E⁷ represents the group

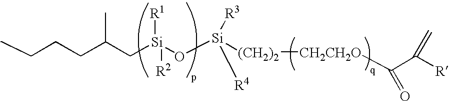

In other embodiments of the present invention, acryl chloride or methacryl chloride employed in the last step of Scheme 3 can be replaced by, for example, isocyanatoethyl(meth)acrylate or glycidyl(meth)acrylate as alternatives for providing terminal (meth)acrylate groups on the star macromonomer. Alternatively, compound XXXIII can be reacted with a fumaryl chloride ester, VDMO, or chloromethylstyrene (such as 4-chloromethylstyrene) to produce a star macromonomer having terminal polymerizable double bonds.

Thus, in one aspect, a star macromonomer of the present invention generally has Formula XXXVI. 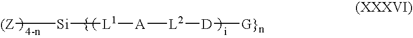
wherein A, D, and G are defined above; L¹ and L² are independently selected from the group consisting of direct bonds and divalent groups; i is an integer such that 1≦i≦1000 (or, alternatively, 1≦i≦500, or 1≦i≦100, or 1≦i≦50, or 1≦i≦10); n is an integer selected from the group consisting of 3 and 4; and Z is selected from the group consisting of hydrogen and groups comprising elements selected from the group consisting of carbon, hydrogen, oxygen, nitrogen, silicon, phosphorus, sulfur, halogen, and combinations thereof. In one embodiment, Z can be a linear, branched, cyclic, saturated, or unsaturated group. In another embodiment L¹ and L² independently comprise linear, branched, or cyclic groups comprising carbon, hydrogen, heteroatoms (such as, for example, oxygen, silicon, nitrogen, phosphorus, sulfur, halogen, or combinations thereof), or combinations thereof.

In still another aspect, the present invention provides a polymeric material comprising a product of a polymerization of one or more star macromonomers, for example those within the scope of the star macromonomers disclosed herein.

In still another aspect, the present invention provides a polymeric material comprising a product of a polymerization of a star macromonomer (for example one within the scope of the star macromonomers disclosed herein) and at least another monomer selected from the group consisting of hydrophobic monomers, hydrophilic monomers, combinations thereof, and mixtures thereof.

Hydrophilic monomers can be nonionic monomers, such as 2-hydroxyethyl methacrylate (“HEMA”), 2-hydroxyethyl acrylate (“HEA”), 2-(2-ethoxyethoxy)ethyl(meth)acrylate, glyceryl(meth)acrylate, polyethylene glycol(meth)acrylate, tetrahydrofurfuryl(meth)acrylate, (meth)acrylamide, N,N′-dimethylmethacrylamide, N,N′-dimethylacrylamide, N-vinyl-2-pyrrolidone (or other N-vinyl lactams), N-vinyl acetamide, and combinations thereof. Other hydrophilic monomers can have more than one polymerizable group, such as tetraethylene glycol(meth)acrylate, triethylene glycol(meth)acrylate, tripropylene glycol(meth)acrylate, ethoxylated bisphenol-A(meth)acrylate, pentaerythritol(meth)acrylate, pentaerythritol(meth)acrylate, ditrimethylolpropane(meth)acrylate, ethoxylated trimethylolpropane(meth)acrylate, dipentaerythritol(meth)acrylate, alkoxylated glyceryl(meth)acrylate. Still further examples of hydrophilic monomers are the vinyl carbonate and vinyl carbamate monomers disclosed in U.S. Pat. No. 5,070,215, and the hydrophilic oxazolone monomers disclosed in U.S. Pat. No. 4,910,277. The contents of these patents are incorporated herein by reference. The hydrophilic monomer also can be an anionic monomer, such as 2-methacryloyloxyethylsulfonate salts. Substituted anionic hydrophilic monomers, such as from acrylic and methacrylic acid, can also be utilized wherein the substituted group can be removed by a facile chemical process. Non-limiting examples of such substituted anionic hydrophilic monomers include trimethylsilyl esters of (meth)acrylic acid, which are hydrolyzed to regenerate an anionic carboxyl group. The hydrophilic monomer also can be a cationic monomer selected from the group consisting of 3-methacrylamidopropyl-N,N,N-trimethyammonium salts, 2-methacryloyloxyethyl-N,N,N-trimethylammonium salts, and amine-containing monomers, such as 3-methacrylamidopropyl-N,N-dimethylamine. Other suitable hydrophilic monomers will be apparent to one skilled in the art.

Non-limiting examples of hydrophobic monomers are C₁-C₂₀ alkyl and C₃-C₂₀ cycloalkyl(meth)acrylates, substituted and unsubstituted aryl(meth)acrylates (wherein the aryl group comprises 6 to 36 carbon atoms), (meth)acrylonitrile, styrene, lower alkyl styrene, lower alkyl vinyl ethers, and C₂-C₁₀ perfluoroalkyl(meth)acrylates and correspondingly partially fluorinated (meth)acrylates. Other examples of hydrophobic monomers are polysiloxanes having one or more fluorinated side groups (e.g., —(CF₂)ₓ—R″, wherein R″ is H, F, or lower alkyl; x is an integer, such as from 1 to 10). The fluorination of certain monomers used in the formation of silicone hydrogels has been indicated to reduce the accumulation of deposits on contact lenses made therefrom, as described in U.S. Pat. Nos. 4,954,587, 5,079,319 and 5,010,141, which are incorporated herein by reference.

In yet another aspect, each of the star macromonomers, hydrophilic monomers, and hydrophobic monomers, when present, comprises from about 5 to about 60 percent (by weight) of a polymeric material of the present invention.

A medical device, such as an ophthalmic device, which may be a contact lens, comprising a polymeric material of the present invention can have an equilibrium water content from about 5 to about 80, or from about 10 to about 60, or from 20 to about 60 percent; an oxygen permeability (Dk) greater than about 50, or 60, or 70, or 80, or 100 barrers. In addition, such an ophthalmic device is expected to have cation transport rates higher than those of prior-art devices that do not comprise a linear or cyclic poly(ethylene oxide) disclosed herein.

A polymeric material of the present invention can comprise units of one or more materials selected from the group of crosslinking agents, strengthening agents, and/or radiation absorbers (such as ultraviolet (“UV”) absorbers and/or absorbers of visible light in the wavelengths of violet and/or blue light). In addition, in carrying out a polymerization of the materials of the present invention, one or more polymerization initiators are desirably included in a starting mixture.

Non-limiting examples of suitable crosslinking agents include ethylene glycol dimethacrylate (“EGDMA”); diethylene glycol dimethacrylate; ethylene glycol diacrylate; triethylene glycol dimethacrylate; triethylene diacrylate; allyl methacrylates; allyl acrylates; 1,3-propanediol dimethacrylate; 1,3-propanediol diacrylate; 1,6-hexanediol dimethacrylate; 1,6-hexanediol diacrylate; 1,4-butanediol dimethacrylate; 1,4-butanediol diacrylate; trimethylolpropane trimethacrylate (“TMPTMA”); glycerol trimethacrylate; poly(ethyleneoxide mono- and di-acrylate); N,N′-dihydroxyethylene bisacrylamide; diallyl phthalate; triallyl cyanurate; divinylbenzene; ethylene glycol divinyl ether; N,N-methylene-bis-(meth)acrylamide; divinylbenzene; divinylsulfone; and the like.

Although not required, polymeric materials within the scope of the present invention may optionally have one or more strengthening agents added prior to polymerization, preferably in quantities of less than about 80 weight percent, but more typically from about 10 to about 60 weight percent, or from about 10 to about 30 weight percent. Non-limiting examples of suitable strengthening agents are described in U.S. Pat. Nos. 4,327,203; 4,355,147; and 5,270,418; each of which is incorporated herein in its entirety by reference. Specific examples, not intended to be limiting, of such strengthening agents include cycloalkyl acrylates and methacrylates; e.g., tert-butylcyclohexyl methacrylate and isopropylcyclopentyl acrylate.

Suitable UV light absorbers for use in the present invention include for example, but are not limited to, β-(4-benzotriazoyl-3-hydroxyphenoxy)ethyl acrylate; 4-(2-acryloxyethoxy)-2-hydroxybenzophenone; 4-methacryloyloxy-2-hydroxybenzophenone; 2-(2′-methacryloyloxy-5′-methylphenyl)benzotriazole; 2-(2′-hydroxy-5′-methacryloxyethylphenyl)-2H-benzotriazole; 2-[3′-tert-butyl-2′-hydroxy-5′-(3″-methacryloyloxypropyl)phenyl]-5-chlorobenzotriazole; 2-(3′-tert-butyl-5′-(3″-dimethylvinylsilylpropoxy)-2′-hydroxyphenyl]-5-methoxybenzotriazole; 2-(3′-allyl-2′-hydroxy-5′-methylphenyl)benzotriazole; 2-[3′-tert-butyl-2′-hydroxy-5′-(3″-methacryloyloxypropoxy)phenyl]-5-methoxybenzotriazole, and 2-[3′-tert-butyl-2′-hydroxy-5′-(3″-methacryloyloxypropoxy)phenyl]-5-chlorobenzotriazole. Preferably, the UV light absorber also has a polymerizable functional group. In one embodiment, the preferred UV light absorbers are β-(4-benzotriazoyl-3-hydroxyphenoxy)ethyl acrylate and 2-[3′-tert-butyl-2′-hydroxy-5′-(3″-methacryloyloxypropoxy)phenyl]-5-chlorobenzotriazole.

Suitable blue or violet light absorbers are the azo dyes. Non-limiting of azo dyes are disclosed in U.S. Pat. Nos. 6,878,792 and 5470,932, each of which is incorporated herein by reference.

One or more suitable free radical polymerization initiators may be desirably added to a mixture of star macromonomers with or without other monomers for making a polymeric material of the present invention. These initiators include thermal polymerization initiators and photopolymerization initiators. Thermal polymerization initiators include organic peroxy compounds and azobis(organonitrile) compounds. Non-limiting examples of suitable organic peroxy compounds include peroxymonocarbonate esters, such as tert-butylperoxy isopropyl carbonate; peroxydicarbonate esters, such as di(2-ethylhexyl)peroxydicarbonate, di(sec-butyl)peroxydicarbonate and diisopropyl peroxydicarbonate; diacyl peroxides, such as 2,4-dichlorobenzoyl peroxide, isobutyryl peroxide, decanoyl peroxide, lauroyl peroxide, propionyl peroxide, acetyl peroxide, benzoyl peroxide, p-chlorobenzoyl peroxide; peroxyesters, such as t-butylperoxy pivalate, t-butylperoxy octylate, and t-butylperoxy isobutyrate; methylethylketone peroxide; and acetylcyclohexane sulfonyl peroxide. Non-limiting examples of suitable azobis(organonitrile) compounds include azobis(isobutyronitrile); 2,2′-azobis(2,4-dimethylpentanenitrile); 1,1′-azobiscyclohexanecarbonitrile; and azobis(2,4-dimethylvaleronitrile); and mixtures thereof. Preferably, such an initiator is employed in a concentration of approximately 0.01 to 1 percent by weight of the total monomer mixture.

Representative UV photopolymerization initiators include those known in the field, such as the classes of benzophenone and its derivatives, benzoin ethers, and phosphine oxides. Some non-limiting examples of these initiators are benzophenone; 4,4!-bis(dimethylamino)benzophenone; 4,4′-dihydroxybenzophenone; 2,2-diethoxyacetophenone; 2,2-dimethoxy-2-phenylacetophenone; 4-(dimethylamino)benzophenone; 2,5-dimethylbenzophenone; 3,4-dimethybenzophenone; 4′-ethoxyacetophenone; 3′-hydroxyacetophenone; 4′-hydroxyacetophenone; 3-hydroxybenzophenone; 4-hydroxybenzophenone; 1-hydroxycyclohexyl phenyl ketone; 2-hydroxy-2-methylpropiophenone; 2-methylbenzophenone; 3-methylbenzophenone; 4′-phenoxyacetophenone; 2-methyl-4′-(methylthio)-2-morpholinopropiophenone; benzoin methyl ether; benzoin ethyl ether; diphenyl(2,4,6-trimethylbenzoyl)phosphine oxide. These initiators are commercially available. Other photo polymerization initiators are known under the trade names Darocur™ and Irgacure™, such as Darocur™ 1173 (2-hydroxy-2-methyl-1-phenyl-1-propanone), Irgacure™ 651 (2,2-dimethoxy-2-phenylacetophenone), Irgacure™ 819 (phenyl-bis(2,4,6-trimethyl benzoyl)phosphine oxide), and Irgacure™ 184 (1-hydroxy cyclohexyl phenyl ketone) from Ciba-Geigy, Basel, Switzerland. Other desirable photopolymerization initiators are those activatable by visible light, for example, blue light.

In another aspect, a method for making a star macromonomer comprises: (a) effecting a polymerization of a first monomeric units on a multi-functional initiator to produce a first star-shaped compound having multiple side chains, each of which has a terminal charge; (b) effecting a polymerization of a second monomeric units on the first star-shaped compound to produce a second star-shaped compound having multiple side chains comprising a segment of first monomeric units and a segment of second monomeric units; and (c) attaching polymerizable groups to terminal groups of the multiple side chains of the second star-shaped compound to produce the star macromonomer. In one embodiment, said polymerization comprises an anionic polymerization. In another embodiment, the multi-functional initiator comprises a multicarbanionic initiator or a derivative thereof. In still another embodiment, the multi-functional initiator comprises a multi-functional silane group, a multi-functional siloxy group, or a derivative thereof.

In still another aspect, the method further comprises effecting anionic polymerization of additional monomeric units, which may be the same or different from the first and second monomeric units before the step of attaching polymerizable groups to terminal groups of the multiple side chains, thus producing a star macromonomer having different domains comprising different monomeric units.

In still another aspect, the present invention also provides a method for making a polymeric material that has an improved oxygen permeability and ion and water transport rates. The method comprises polymerizing at least a star macromonomer of the present invention alone or in combination with units of another hydrophilic monomer, hydrophobic monomer, or combinations thereof. In one aspect, the polymeric material has an oxygen permeability greater than about 50 barrers. Alternative embodiments of the polymeric materials have oxygen permeability greater than about 60, 70, 80, or 90 barrers. A polymeric material of the present invention has ion and water transport rates greater than those of a material that does not comprise a star macromonomer within the scope of those disclosed herein, exemplary structures of which are disclosed above.

A polymeric material comprising units of a star macromonomer of the present invention can have regularly distributed hydrophilic domains to promote the diffusion of water and ions therethrough.

In yet another aspect, a method of making a medical device comprises: (a) disposing a composition comprising a star macromonomer that comprises segments of hydrophobic units and hydrophilic units in a mold, which has a cavity having a shape of the medical device; and (b) polymerizing the composition to form the medical device. The medical device thus formed can then be removed from the cavity of the mold. In one embodiment of the method, the star macromonomer comprises a nucleus and multiple side chains attached to the nucleus, each side chain having at least one segment of hydrophilic units and at least one segment of hydrophobic units.

In still another aspect, a method of making a medical device comprises: (a) forming a solid block of a polymeric material comprising units of a star macromonomer that has segments of hydrophobic units and hydrophilic units; and (b) shaping the block to form the medical device. In one embodiment of the method, the step of shaping comprises: (a) cutting the block into wafers; and (b) machining or lathing the wafer into the form of the medical device.

In some embodiments, the polymeric material further comprises units of additional hydrophilic monomers or hydrophobic monomers. Such monomers can be selected from those disclosed herein above.

In some embodiments, the step of polymerizing a composition comprising the star macromonomer with or without said additional monomers is carried out at a temperature from about ambient temperature to about 120° C., or from about ambient temperature to about 100° C., in the presence of a thermal polymerization initiator. Alternatively, the step of polymerization can be carried out under irradiation, for example, UV or visible-light irradiation, in the presence of a photo polymerization initiator.

Polymeric materials of the present invention are advantageously used in the manufacture of ophthalmic devices, such as contact lenses, corneal inlays, corneal rings, intraocular lenses (“IOL”), and keroprotheses.

Methods of using such ophthalmic devices are well known. For example, in a surgical cataract procedure, an incision is placed in the cornea of an eye. Through the corneal incision the cataractous natural lens of the eye is removed (aphakic application) and an IOL is inserted into the anterior chamber, posterior chamber or lens capsule of the eye prior to closing the incision. However, the subject ophthalmic devices may likewise be used in accordance with other surgical procedures known to those skilled in the field of ophthalmology.

While specific embodiments of the present invention have been described in the foregoing, it will be appreciated by those skilled in the art that many equivalents, modifications, substitutions, and variations may be made thereto without departing from the spirit and scope of the invention as defined in the appended claims.

What is claimed is:

1. A star macromonomer comprising multiple side chains attached to a nucleus, each side chain having at least a segment comprising hydrophobic units and at least a segment comprising hydrophilic units.

2. The star macromonomer of claim 1, comprising at least three side chains, each side chain comprising a terminal polymerizable group.

3. The star macromonomer of claim 2, wherein the polymerizable group is selected from the group consisting of vinyl, allyl, vinyloxy, acryloyl, acryloyloxy, methacryloyl, methacryloyloxy, epoxide, isocyanate, isothiocyanate, amino, hydroxyl, mercapto, anhydride, carboxylic, fumaryl, styryl, itaconyl, maleimido, methacrylamido, acrylamido, and combinations thereof.

4. The star macromonomer of claim 2, wherein the polymerizable group is selected from the group consisting of vinyl, allyl, acryloyl, acryloyloxy, methacryloyl, methacryloyloxy, fumaryl, styryl, and combinations thereof.

5. The star macromonomer of claim 1, wherein each side chain comprises a plurality of alternate hydrophilic and hydrophobic segments.

6. The star macromonomer of claim 1, wherein said at least a hydrophobic segment comprises a plurality of siloxy units.

7. The star macromonomer of claim 6, wherein a side group of the siloxy units comprises at least an unsubstituted or substituted C₆-C₃₆ aromatic group.

8. The star macromonomer of claim 6, wherein a side group of the siloxy units comprises a fluorinated hydrocarbon group.

9. The star macromonomer of claim 1, wherein the nucleus comprises a multicarbanionic group, a multifunctional silane group, a multifunctional siloxy group, or a derivative thereof.

10. The star macromonomer of claim 1, having a formula selected from the group of Formulas II, III, and XXXVI 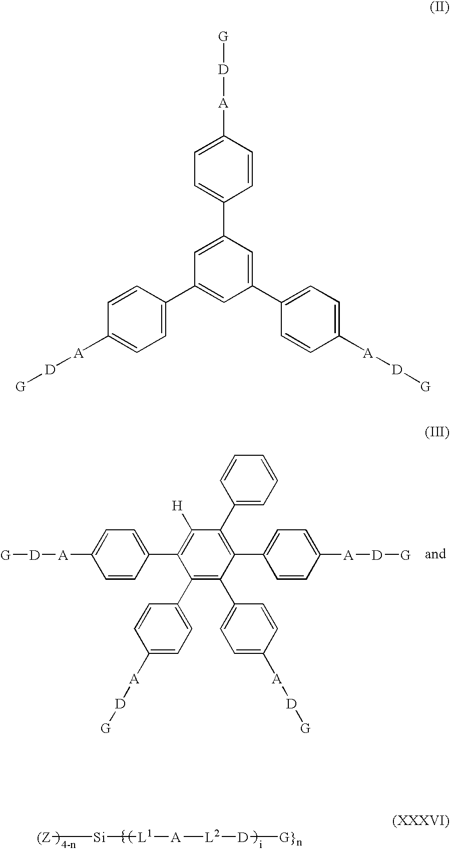
wherein A comprises a segment comprising a plurality of hydrophobic monomeric units or hydrophilic units; D comprises: (a) a segment comprising a plurality of hydrophilic monomeric units if A comprises a segment comprising a plurality of hydrophobic monomeric units, or (b) a segment comprising a plurality of hydrophobic monomeric units if A comprises a segment comprising a plurality of hydrophilic monomeric units; G comprises a polymerizable group; L¹ and L² are independently selected from the group consisting of direct bonds and divalent groups; i is an integer such that 1≦i≦1000; n is an integer selected from the group consisting of 3 and 4; and Z is selected from the group consisting of hydrogen and groups comprising elements selected from the group consisting of carbon, hydrogen, oxygen, nitrogen, silicon, phosphorus, sulfur, halogen, and combinations thereof.

11. The star macromonomer of claim 10, wherein A comprises polysiloxane, D comprises polyoxyethylene or poly(N-vinylpyrrolidone), and n=4.

12. A polymeric material comprising units of a star macromonomer that comprises multiple side chains attached to a nucleus, each side chain having at least a segment comprising hydrophobic units and at least a segment comprising hydrophilic units.

13. The polymeric material of claim 12, wherein each side chain comprises a plurality of alternate hydrophilic and hydrophobic segments.

14. The polymeric material of claim 12, wherein said at least a hydrophobic segment comprises a plurality of siloxy units.

15. The polymeric material of claim 14, wherein a side group of the siloxy units comprises at least an unsubstituted or substituted C₆-C₃₆ aromatic group.

16. The polymeric material of claim 14, wherein a side group of the siloxy units comprises a fluorinated hydrocarbon group.

17. The polymeric material of claim 12, wherein the nucleus comprises a multicarbanionic group, a multifunctional silane group, a multifunctional siloxy group, or a derivative thereof.

18. The polymeric material of claim 12, wherein the star macromonomer of claim 1, having a formula selected from the group of Formulas II, III, and XXXVI 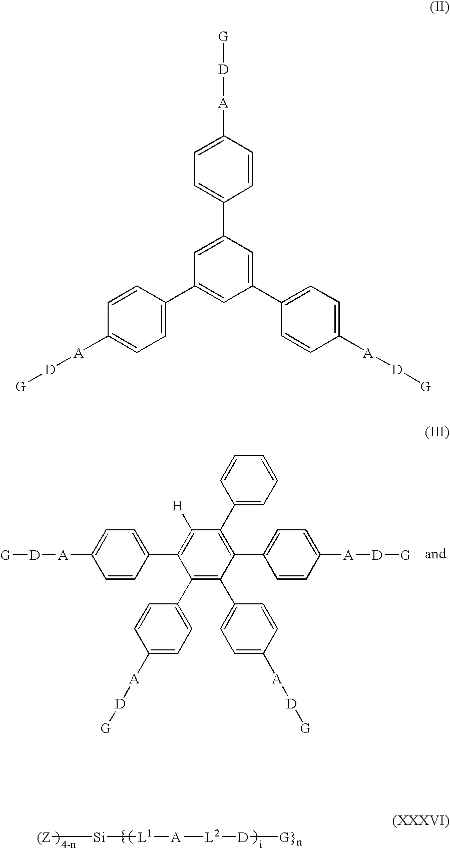
wherein A comprises a segment comprising a plurality of hydrophobic monomeric units or hydrophilic units; D comprises: (a) a segment comprising a plurality of hydrophilic monomeric units if A comprises a segment comprising a plurality of hydrophobic monomeric units, or (b) a segment comprising a plurality of hydrophobic monomeric units if A comprises a segment comprising a plurality of hydrophilic monomeric units; G comprises a polymerizable group; L¹ and L² are independently selected from the group consisting of direct bonds and divalent groups; i is an integer such that i≦i≦1000; n is an integer selected from the group consisting of 3 and 4; and Z is selected from the group consisting of hydrogen and groups comprising elements selected from the group consisting of carbon, hydrogen, oxygen, nitrogen, silicon, phosphorus, sulfur, halogen, and combinations thereof.

19. The polymeric material of claim 18, further comprising units of a monomer selected from the group consisting of hydrophilic monomers, hydrophobic monomers, and combinations thereof.

20. The polymeric material of claim 19, further comprising units of a radiation absorber.

21. The polymeric material of claim 20, wherein the radiation absorber is capable of absorbing at least a portion of UV radiation or visible light having wavelengths in a range of violet or blue light.

22. The polymeric material of claim 12, wherein the polymeric material has an oxygen permeability (Dk) greater than about 50 barrers.

23. A method for making a star macromonomer, the method comprising:
(a) effecting a polymerization of a first monomeric units on a multi-functional initiator to produce a first star-shaped compound having multiple side chains;
(b) effecting a polymerization of a second monomeric units on the first star-shaped compound to produce a second star-shaped compound having multiple side chains comprising a segment of first monomeric units and a segment of second monomeric units; and
(c) attaching polymerizable groups to terminal groups of the multiple side chains of the second star-shaped compound to produce the star macromonomer.

24. The method of claim 23, wherein the polymerization of steps (a) and (b) comprises an anionic polymerization.

25. The method of claim 23, wherein the multi-functional initiator is selected from the group consisting of a multicarbanionic initiator, a multi-functional silane group, a multi-functional siloxy group, and derivatives thereof.

26. The method of claim 23, further comprising effecting a polymerization of additional monomeric units before step (c).

27. The method of claim 26, wherein said additional monomeric units are the same as said first monomeric units, or different from both said first monomeric units and said second monomeric units.

28. The method of claim 23, further comprising effecting a polymerization of the first monomeric units on the second star-shaped compound to produce a third star-shaped compound before attaching polymerizable groups.

29. The method of claim 28, further comprising effecting a polymerization of the second monomeric units on the third star-shaped compound to produce a fourth star-shaped compound before attaching polymerizable groups.

30. A method for making a polymeric material that has an improved oxygen permeability and ion and water transport rates, the method comprising polymerizing at least a star macromonomer alone or in combination with units of a hydrophilic monomer, a hydrophobic monomer, or combinations thereof, wherein the star macromonomer comprises multiple side chains attached to a nucleus, each side chain having at least a segment comprising hydrophobic units and at least a segment comprising hydrophilic units.

31. The method of claim 30, wherein the star macromonomer has a formula selected from the group of Formulas II, III, and XXXVI 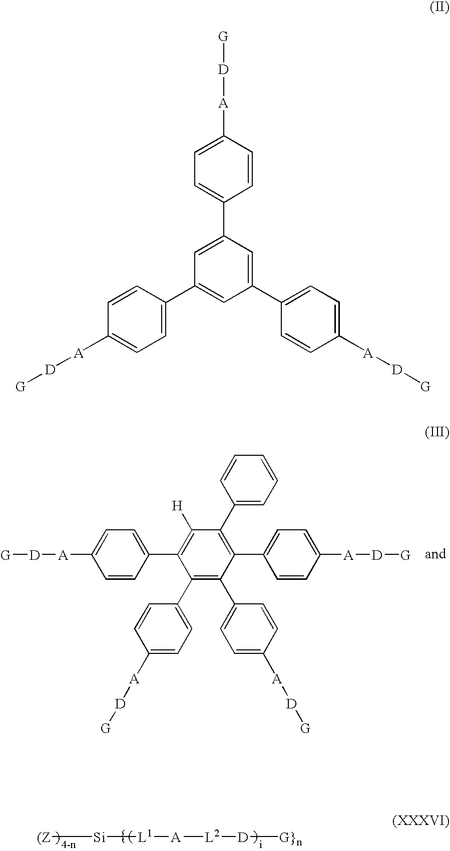
wherein A comprises a segment comprising a plurality of hydrophobic monomeric units or hydrophilic units; D comprises: (a) a segment comprising a plurality of hydrophilic monomeric units if A comprises a segment comprising a plurality of hydrophobic monomeric units, or (b) a segment comprising a plurality of hydrophobic monomeric units if A comprises a segment comprising a plurality of hydrophilic monomeric units; G comprises a polymerizable group; L¹ and L² are independently selected from the group consisting of direct bonds and divalent groups; i is an integer such that 1≦i≦1000; n is an integer selected from the group consisting of 3 and 4; and Z is selected from the group consisting of hydrogen and groups comprising elements selected from the group consisting of carbon, hydrogen, oxygen, nitrogen, silicon, phosphorus, sulfur, halogen, and combinations thereof.

32. A method of making a medical device, the method comprising:
(a) disposing a composition comprising a star macromonomer that comprises segments of hydrophobic units and hydrophilic units in a mold, which has a cavity having a shape of the medical device; and
(b) polymerizing the composition to form the medical device.

33. The method of claim 32, wherein the medical device is an ophthalmic device.

34. A method of making a medical device, the method comprising:
(a) forming a solid block of a polymeric material comprising units of a star macromonomer that has segments of hydrophobic units and hydrophilic units; and
(b) shaping the block to form the medical device.

35. The method of claim 34, wherein the step of shaping comprises: (i) cutting the block into wafers; and (ii) machining or lathing the wafer into the form of the medical device.

36. The method of claim 34, wherein the medical device is an ophthalmic device.

37. A medical device comprising a polymeric material that comprises units of a star macromonomer that comprises multiple side chains attached to a nucleus, each side chain having at least a segment comprising hydrophobic units and at least a segment comprising hydrophilic units.

38. The medical device of claim 37, wherein each side chain comprises a plurality of alternate hydrophilic and hydrophobic segments.

39. The medical device of claim 37, wherein said at least a hydrophobic segment comprises a plurality of siloxy units.

40. The medical device of claim 39, wherein the medical device is a contact lens, an intraocular lens, a corneal inlay, a cornela ring, or a keroprothesis.

41. The medical device of claim 39, wherein a side group of the siloxy units comprises at least an unsubstituted or substituted C₆-C₃₆ aromatic group.

42. The medical device of claim 39, wherein a side group of the siloxy units comprises a fluorinated hydrocarbon group.

43. The medical device of claim 37, wherein the nucleus comprises a multicarbanionic group, a multifunctional silane group, a multifunctional siloxy group, or a derivative thereof.

44. The medical device of claim 37, wherein the star macromonomer of claim 1, having a formula selected from the group of Formulas II, III, and XXXVI 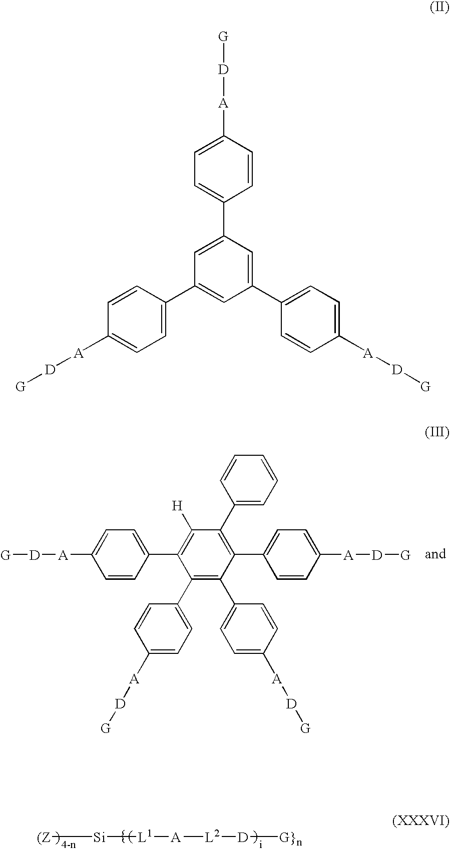
wherein A comprises a segment comprising a plurality of hydrophobic monomeric units or hydrophilic units; D comprises: (a) a segment comprising a plurality of hydrophilic monomeric units if A comprises a segment comprising a plurality of hydrophobic monomeric units, or (b) a segment comprising a plurality of hydrophobic monomeric units if A comprises a segment comprising a plurality of hydrophilic monomeric units; G comprises a polymerizable group; L¹ and L² are independently selected from the group consisting of direct bonds and divalent groups; i is an integer such that i≦i≦1000; n is an integer selected from the group consisting of 3 and 4; and Z is selected from the group consisting of hydrogen and groups comprising elements selected from the group consisting of carbon, hydrogen, oxygen, nitrogen, silicon, phosphorus, sulfur, halogen, and combinations thereof.

45. The medical device of claim 37, further comprising units of a monomer selected from the group consisting of hydrophilic monomers, hydrophobic monomers, and combinations thereof.

46. The medical device of claim 45, further comprising units of a radiation absorber.

47. The medical device of claim 46, wherein the radiation absorber is capable of absorbing at least a portion of UV radiation or visible light having wavelengths in a range of violet or blue light.

48. The medical device of claim 37, wherein the polymeric material has an oxygen permeability (Dk) greater than about 50 barrers.
